(19) United States
(12) Patent Application Publication
(10) Pub. No.: US 2001/0026670 A1
(43) Pub. Date: Oct. 4, 2001

(54) Optical waveguide and method for making the same

(75) Inventors: Toshiyuki Takizawa, Nagahama-shi (JP); Masahiro Kito, Osaka (JP)

Correspondence Address: PARKHURST & WENDEL, L.L.P., Suite 210, 1421 Prince Street, Alexandria, VA, 22314-2805, US

(73) Assignee: MATSUSHITA ELECTRIC INDUSTRIAL CO., LTD.

(21) Appl. No.: 09/817,263

(22) Filed: Mar. 27, 2001

(30) Foreign Application Priority Data
Mar. 28, 2000 (JP) 2000-088030

(51) Int. Cl. G02B 6/122

(52) U.S. Cl. 385/129; 385/132; 216/24

(57) ABSTRACT

To provide an optical waveguide having an optical waveguide core enclosed with clads, which is independent of a polarization direction. In the optical waveguide, an optical waveguide core is enclosed with clads, and a sectional shape of the core in a direction crossing a light traveling direction is quasi-square, and a cross section of the core decreases from the light incoming end to the outgoing end in the light traveling direction.

### FIELD OF THE INVENTION

The present invention relates to an optical waveguide and a method for making the same.

### BACKGROUND OF THE INVENTION

In recent years, the development of optical active elements and optical function modules represented by semiconductor laser is being carried forward rapidly towards a sophisticated information society such as an optical subscriber communication network.

On the other hand, it is anticipated that optical fibers will be laid up to each household and use of an optical communication terminal at each household will be widespread. For this reason, there is a demand for the development of a technology for mass production of optical communication modules that will connect optical fibers and optical circuits at low prices.

At present, a fitting method by which an optical fiber is fitted into a V-figured groove formed on a substrate is generally used as a method for connecting an optical fiber and an optical circuit. By the way, in a waveguide used for an optical circuit, the difference in refractive index between a core section and clad section is approximately 1%. Thus, when a curved waveguide or branch is formed, a large radius of curvature and a shape with few variations are required to prevent leakage light at locations where the shape of the waveguide changes. This increases the size of an optical circuit in the case of a waveguide with a low difference in the refractive index.

On the other hand, increasing the difference in the refractive index involves a problem that the outgoing light from the waveguide will have a large radiation angle, which will deteriorate the efficiency of coupling with the optical fiber or waveguide.

To implement high efficiency of coupling with the optical fiber, laser that integrates a spot-size converter is recently under development. This method narrows the radiation angle by weakening the effect of light trapping at the outgoing end of laser.

FIG. 25 is a perspective view of a conventional semiconductor laser with a spot size conversion function. In FIG. 25, a core 12 is formed inside a semiconductor laser chip 11. The core 12 is actually placed between clad layers, etc. of a refractive index lower than that of the core 12, but for ease of figuring out the shape of the core 12, the clad layers, etc. are omitted in this figure.

The breadth of the core 12 becomes smaller in the direction of the outgoing radiation of light. The thickness of the core 12 is constant from the incoming end to the outgoing end. Therefore, trapping of laser light at the front-end section 12a is weakened considerably. Thus, laser light is emitted from the front end section 12a at a narrow radiation angle.

### SUMMARY OF THE INVENTION

By the way, a semiconductor laser generally oscillates only with certain polarization. For this reason, there is no problem even if the core 12 has a vertically or horizontally asymmetric sectional shape. However, it is the actual situation that the waveguide in an optical communication module that connects an optical fiber and an optical circuit is required to output with a constant loss at the outgoing end regardless of the direction in which polarized light is input to the incoming end.

It is an object of the present invention to provide an optical waveguide having an optical waveguide core enclosed with clads, independent of the polarization direction.

Making the above optical waveguide independent of the polarization direction requires a complicated core whose shape varies three-dimensionally, but it is an object of the present invention to provide a method for making an optical waveguide, capable of forming this core whose shape varies three-dimensionally without using complicated processes.

The optical waveguide according to claim 1 of the present invention is an optical waveguide having an optical waveguide core enclosed with clads, characterized in that a cross section of the core in a direction crossing the light traveling direction varies.

The optical waveguide according to claim 2 of the present invention is an optical waveguide having an optical waveguide core enclosed with clads, characterized by comprising a groove formed on the surface of a substrate so that its cross section varies in a light traveling direction and a core formed on the groove via the clad, whose cross section varies in the light traveling direction.

The optical waveguide according to claim 3 of the present invention is characterized in that the cross section of the core according to claim 1 or claim 2 decreases from a light incoming end to an outgoing end in the light traveling direction.

The optical waveguide according to claim 4 of the present invention is characterized in that the section of the core according to any one of claims 1 to 3 has a quasi-square shape.

The optical waveguide according to claim 5 of the present invention is characterized in that a reflective film is formed on a bottom face or inner surface of the groove according to any one of claims 1 to 3.

The method for making an optical waveguide according to claim 6 of the present invention is a method for making an optical waveguide having an optical waveguide core formed on a substrate, characterized by forming a mask with a band-shaped opening formed in a setting direction of the optical waveguide core on the substrate and changing the width of the opening in the setting direction, etching a surface of the substrate exposed to the opening by using the mask to form a groove whose depth varies in the setting direction, forming a clad material in the groove, stacking the core material made of light-propagable material from one end to the other end of the groove on the clad material, and etching the core material to form the core whose cross section decreases from one end to the other end of the groove in a light traveling direction.

The method for making an optical waveguide according to claim 7 of the present invention is a method for making an optical waveguide having an optical waveguide core formed on a substrate, characterized by forming a mask with a band-shaped opening formed in a setting direction of the optical waveguide core on the substrate and curving the shape of the opening from one end to the other end of the groove, etching a surface of the substrate exposed to the opening by using the mask to form a groove whose depth varies in the setting direction, forming a clad material in the groove, stacking a core material made of light-propagable material from one end to the other end of the groove on the clad material, and etching the core material to form the core whose cross section decreases from one end to the other end of the groove in a light traveling direction.

The method for making an optical waveguide according to claim 8 of the present invention is characterized by etching the core material according to claim 6 or claim 7 to form a core whose section has a quasi-square shape.

The method for making an optical waveguide according to claim 9 of the present invention is characterized in that the substrate according to claim 6 or claim 7 is made of silicon, and a main plane of the substrate is a (001) plane and the groove is parallel to a <11\overline{}0>direction of the substrate.

The method for making an optical waveguide according to claim 10 of the present invention is characterized by forming a resist of varying thickness on the semiconductor substrate according to claim 6 and etching the semiconductor substrate together with the resist to form a groove whose depth varies.

The method for making an optical waveguide according to claim 11 of the present invention is characterized by partially forming a resist on the semiconductor substrate according to claim 6, and removing the resist at some midpoint of etching and continuing etching or etching the semiconductor substrate together with the resist without removing the resist at some midpoint of etching to form a groove of varying depth.

The present invention makes it easier to create a core having a varying cross section, and is therefore suitable for mass production.

### BRIEF DESCRIPTION OF THE DRAWINGS

FIG. 1 is a perspective view of an optical waveguide according to (Embodiment 1) of the present invention;

FIG. 2 is an A-A′ sectional view of the optical waveguide above;

FIG. 3 is a B-B′ sectional view of the optical waveguide above;

FIG. 4 is a C-C′ sectional view of the optical waveguide above;

FIG. 5 is a process sectional view at the A-A′ section and a process sectional view at the B-B′ section of the optical waveguide above;

FIG. 6 is a process sectional view at the A-A′ section and a process sectional view at the B-B′ section of the optical waveguide above;

FIG. 7 is a process sectional view at the A-A′ section and a process sectional view at the B-B′ section of the optical waveguide above;

FIG. 8 is a process sectional view at the A-A′ section and a process sectional view at the B-B′ section of the optical waveguide above;

FIG. 9 is an A-A′ sectional view and a B-B′ sectional view of another optical waveguide according to (Embodiment 1) of the present invention;

FIG. 10 is a concrete making process diagram using a wafer of the present invention;

FIG. 11 is a perspective view of an optical waveguide according to (Embodiment 2) of the present invention;

FIG. 12 is an A-A′ sectional view of the optical waveguide above;

FIG. 13 is a B-B′ sectional view of the optical waveguide above;

FIG. 14 is a C-C′ sectional view of the optical waveguide above;

FIG. 15 is a process sectional view at the A-A′ section and a process sectional view at the B-B′ section of the optical waveguide above;

FIG. 16 is a process sectional view at the A-A′ section and a process sectional view at the B-B′ section of the optical waveguide above;

FIG. 17 is a perspective view and plan view of an optical waveguide according to (Embodiment 3) of the present invention;

FIG. 18 is an A-A′ sectional view of the optical waveguide above;

FIG. 19 is a B-B′ sectional view of the optical waveguide above;

FIG. 20 is a sectional view of the optical waveguide according to each embodiment of the present invention;

FIG. 21 is a plan view showing another forming a groove of the present invention;

FIG. 22 is a sectional view showing another method for forming a groove of the present invention;

FIG. 23 is a sectional view showing another method for forming a groove of the present invention;

FIG. 24 is a sectional view showing another method for forming a groove of the present invention; and

FIG. 25 is a perspective view showing a conventional optical waveguide.

### DESCRIPTION OF THE EMBODIMENTS

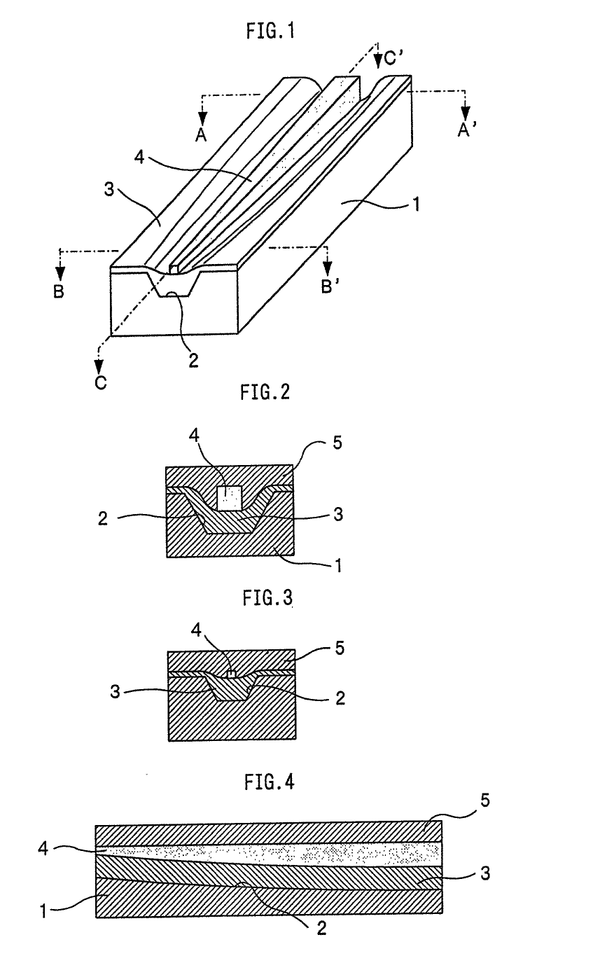

With reference now to FIG. 1 to FIG. 24, embodiments of the present invention will be explained below.

(Embodiment 1)

FIG. 1 to FIG. 4 show (Embodiment 1) of the present invention.

FIG. 1 is a perspective view of an optical waveguide. An upper clad layer 5 shown in FIG. 2 to FIG. 4 is omitted in FIG. 1.

FIG. 2, FIG. 3 and FIG. 4 are an A-A′ sectional view, B-B′ sectional view and C-C′ sectional view of the optical waveguide in FIG. 1, respectively.

In this way, a groove 2 is formed on a semiconductor substrate 1, a lower clad layer 3, a core 4 and an upper clad layer 5 are formed one atop another on the groove 2.

The width and depth of the groove 2 decrease from the A-A′ section of the light incoming end to the B-B′ section of the light outgoing end. That is, the cross section of the groove 2 gradually decreases from the incoming end to the outgoing end.

By the way, the width and depth of the groove 2 can also be fixed up to some midpoint along the length thereof. According to the cross section of the groove 2, the cross section of the core 4 also decreases from the light incoming end to the outgoing end and the cross section of the core 4 is the smallest at the light outgoing end, at which part the effect of trapping into the core 4 of the light propagating through the core 4 is small. Thus, the radiation angle of the outgoing light from the outgoing end is narrow. The sectional shape of the core 4 in the direction crossing the light traveling direction is finished in a quasi-square shape in all parts along the length of the waveguide.

Then, the method for making such an optical waveguide will be explained below.

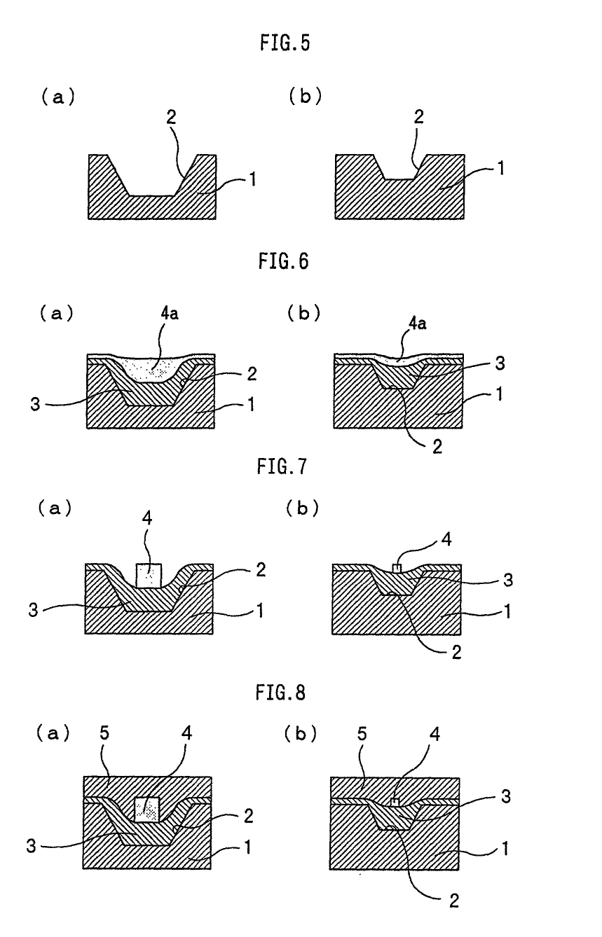

FIG. 5A, FIG. 6A, FIG. 7A and FIG. 8A are process sectional views showing the A-A′ section of the optical waveguide shown in FIG. 1. FIG. 5B, FIG. 6B, FIG. 7B and FIG. 8B are process sectional views showing the B-B′ section of the same optical waveguide.

First, as shown in FIG. 5A and FIG. 5B, the groove 2 is formed on the semiconductor substrate 1 by wet etching.

The clad material and core material 4 are added in that order and the lower clad layer 3 and core layer 4a are formed in that order by spin coating as shown in FIG. 6A and FIG. 6B.

As apparent from a comparison between FIG. 6A and FIG. 6B, the greater the cross section of the groove 2, the greater the cross section of the core layer 4a formed on the groove 2.

Then, as shown in FIG. 7A and FIG. 7B, the core layer 4a formed on the part other the part right above the groove 2 is removed by etching, leaving only the core layer 4a right above the groove 2, that is, the core 4. The sectional shape of the core 4 in the direction crossing the light traveling direction is finished in a quasi-square form in all parts along the length of the waveguide.

Finally, as shown in FIG. 8A and FIG. 8B, by forming the upper clad layer 5 on the lower clad layer 3 and the core 4, the optical waveguide is completed.

As apparent from a comparison between FIG. 7A and FIG. 7B, the greater the cross section of the groove 2, the greater the cross section of the core 4 formed on the groove 2.

Suppose signal light enters from the A-A′ section side. Since the cross section of the core 4 on the A-A′ section is greater, the light is strongly trapped and travels toward the B-B′ section. Since the cross section of the core 4 decreases as the light propagates, the light is not sufficiently trapped and most of the light seeps out of the core 4. The light continues to propagate and when the light reaches the B-B′ section, the light radiates out at a narrow radiation angle.

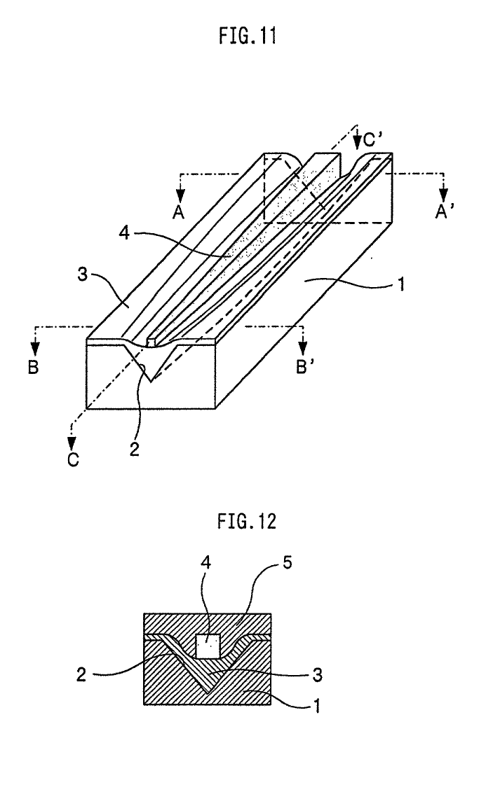

In a specific making process, a plurality of grooves 2a is formed on a wafer 13 as shown in FIG. 10A. The shape of the bottom of each groove 2a does not change monotonously from one end to the other, but the shape of the bottom is etched deep or shallow depending on each section to be one optical waveguide so that each waveguide is cut into chips later to form a plurality of optical waveguides as shown in FIG. 10D.

Then, as shown in FIG. 10B, while rotating the wafer 13 on which the groove 2a is formed as shown in this FIG. 10A, the clad material and core material 4 are added in that order and the lower clad layer 3 and core layer 4a are formed in that order by spin coating, and the core 4 is formed by etching and further the upper clad layer 5 is formed on the lower clad layer 3 and the core 4 as described above.

Then, as shown in FIG. 10C, the wafer is cut into bars and these are further cut into chips to form a plurality of optical waveguides as shown in FIG. 10D.

As shown above, by forming the core 4 on the groove 2 whose cross section varies continuously, it is possible to simply create a spot size converter. Furthermore, since the lower clad layer 3 is formed before forming the core 4, the base of the core 4 is flattened even if the accuracy of surface treatment of the groove 2 is low. This makes it possible to suppress scattering loss of light.

By the way, suppose the width and thickness of the core 4 are to be the same. This is a square waveguide, and so it is possible to create a spot size converter independent of the polarization direction.

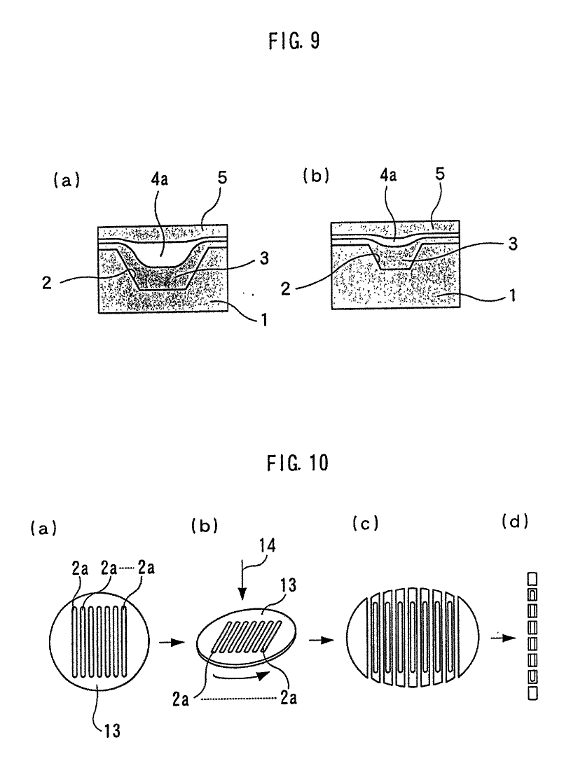

This embodiment describes the case where both the width and depth of the groove 2 change, but the present invention can be implemented by changing either one of width or depth. As shown in FIG. 7A and FIG. 7B, this embodiment describes the case where the core layer 4a formed on the part other than the part right above the groove 2 is removed by etching and the core layer 4a right above the groove 2, that is, the core 4 only, is left, but it is also possible to form the upper clad layer 5 directly on the core layer 4a as shown in FIG. 9A and FIG. 9B without carrying out such a removal process by etching.

In this structure, since the core layer 4a in the groove 2 is thickest, the light is localized in that part and propagates through the core 4a.

In this structure, the shape of the core layer 4a is asymmetric in the vertical and horizontal directions, and therefore the effective index of refraction generally varies with respect to the light in each polarization direction and the intensity distribution of light also varies. Therefore, the symmetry of guided wave mode deteriorates. However, such a method is sufficient as a method for use, which is not so sensitive to the polarization direction. Thus, using this method eliminates the need to remove both sides of the core layer 4a by etching, making it possible to reduce the making process. Moreover, adjusting the sectional shape of the groove 2 can also make the waveguide independent of the polarization direction as in the case of the square waveguide. (Embodiment 1) describes the core 4 whose sectional shape is quasi-square, but it is also possible to adopt as the sectional shape of the core 4 other shapes, which are symmetric with respect to vertical or horizontal directions, for example, circular or quasi-circular. This makes the waveguide independent of the polarization direction. The same will apply to the following embodiments.

(Embodiment 2)

(Embodiment 2) of the present invention will be explained by using the attached drawings.

In the case where a material with an anisotropic etching characteristic is used as the etching material for semiconductors, etc., it is possible to obtain a smooth groove shape. As a typical example, applying etching with a solution of potassium hydroxide to the main surface of a silicon substrate whose main plane is the (001) plane causes the (111) plane to be exposed due to an anisotropic characteristic of the etching speed depending on the plane orientation. The method for forming the groove 2 using this nature will be explained.

FIG. 11 to FIG. 16 show (Embodiment 2) of the present invention.

FIG. 11 is a perspective view of an optical waveguide, but the upper clad layer 5 shown in FIG. 12 to FIG. 14 is omitted here.

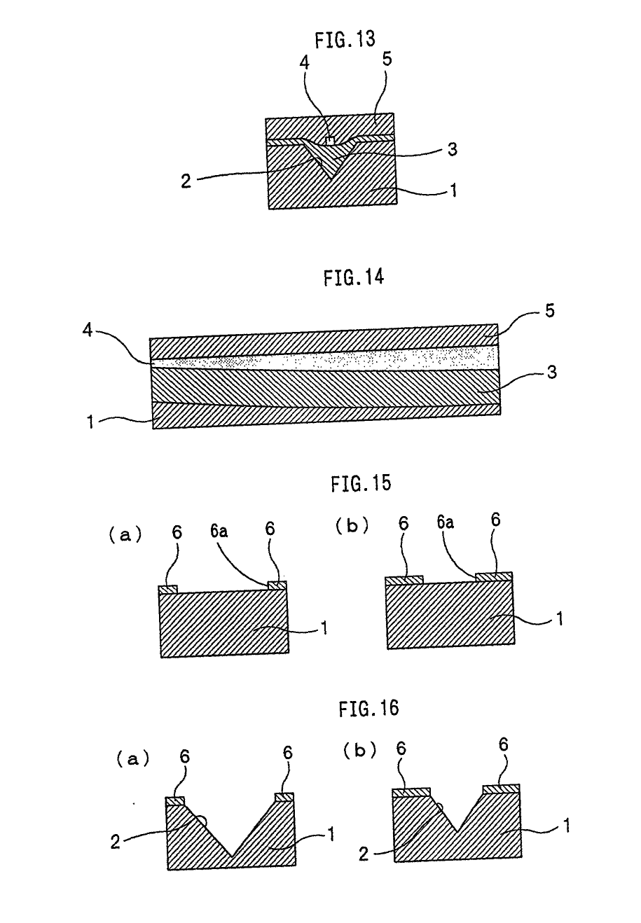

FIG. 12, FIG. 13 and FIG. 14 are an A-A′ sectional view, B-B′ sectional view and C-C′ sectional view of the optical waveguide in FIG. 11, respectively.

In FIG. 11 to FIG. 14, on a semiconductor substrate 1, mainly made of silicon, whose main plane is (001), a groove 2 is formed parallel to the <11\overline{}0> direction and a lower clad layer 3, a core 4 and an upper clad layer 5 (omitted in FIG. 11) are formed one atop another on the groove 2.

The optical waveguide according to (Embodiment 2) is different from the optical waveguide according to (Embodiment 1) in that the sectional shape of the groove 2 is V-figured.

Then, the method for making the optical waveguide according to (Embodiment 2) will be explained.

FIG. 15A and FIG. 16A are process sectional views showing the A-A′ section of the optical waveguide shown in FIG. 11. On the other hand, FIG. 15B and FIG. 16B are process sectional views showing the B-B′ section of the optical waveguide.

First, as shown in FIG. 15A and FIG. 15B, a resist 6 with a belt-like opening 6a is formed on the semiconductor substrate 1 mainly made of silicon. This belt-like opening 6a is parallel to the <001> direction. The width of the opening on the A-A′ section is greater than the width of the opening on the B-B′ section.

Then, as shown in FIG. 16A and FIG. 16B, the groove 2 whose section is V-figured is formed on the semiconductor substrate 1 by etching using the resist 6 as a mask. Then, as in the case of (Embodiment 1), the lower clad layer 3, core 4 and upper clad 5 are formed one by one.

Here, the reason why the section of the groove 2 has a V-figured shape will be explained.

When the semiconductor substrate 1, made of silicon, whose main plane is the <001> direction is etched using the resist 6 with a belt-like opening parallel to the <11\overline{}0> direction formed on the semiconductor substrate 1, the inclined plane of the groove 2 is constant as the (111) plane. Therefore, the section of the groove 2 has a sharp V figure.

Taking advantage of this nature, when the width of, the opening 6a of the resist is made wide on the A-A′ section and narrow on the B-B′ section, then the plane orientation of the inclined plane of the groove 2 is always set to the (111) plane, and therefore it is possible to form the groove 2 having similar shapes with different cross sections on the A-A′ section and the B-B′ section.

That is, when the width of the opening of the resist 6 is determined, then the width and depth of the groove 2 are automatically determined. Furthermore, when the etching selectivity with respect, to both orientations is considerably high, the sectional shape is kept constant even if the etching time is extended somewhat. Therefore, it is possible to uniquely determine the sectional shape of the groove based on the shape of the opening of the resist 6 alone. Thus, it is possible to accurately form the shape of the groove 2 by forming the resist 6 according to the required size of the groove, thus making the making process easier.

This embodiment describes the case where the V-figured groove 2 is formed, but the present invention can also be implemented in the same way also when vertical etching is available such as etching based on hydrochloric acid on indium phosphide.

(Embodiment 3)

(Embodiment 2) describes the method for automatically forming the groove 2 by anisotropic etching. However, especially in the case of anisotropic etching on a semiconductor, the orientation of a plane to be exposed varies with respect to the orientation of the plane on which the groove is formed.

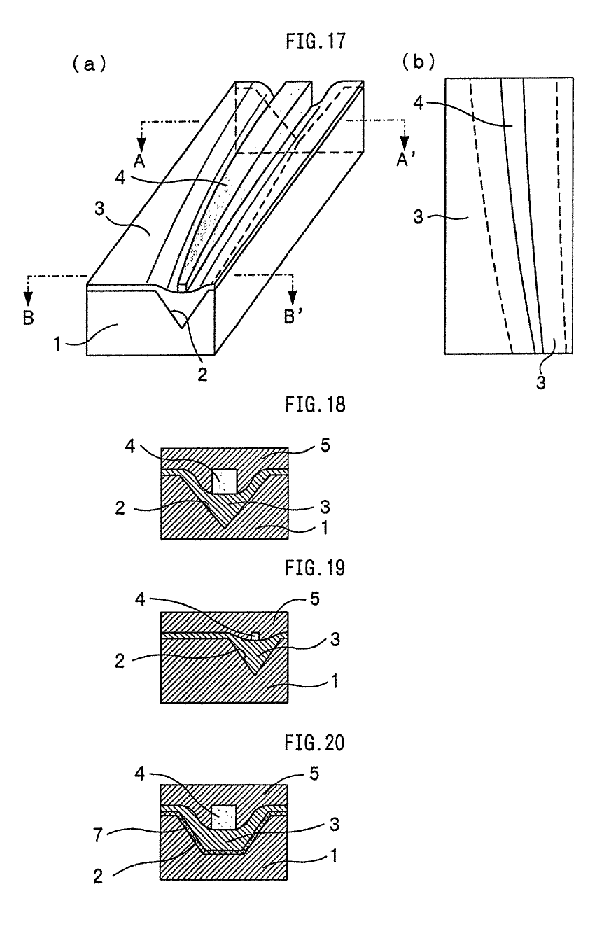

FIG. 17A is a perspective view of the optical waveguide according to (Embodiment 3) of the present invention, but the upper clad layer 5 shown in FIG. 18 to FIG. 20 is omitted. FIG. 17B shows a plan view.

FIG. 18 and FIG. 19 show an A-A′ sectional view and B-B′ sectional view of the optical waveguide in FIG. 17, respectively. In FIG. 17 to FIG. 19, a groove 2 is formed on a semiconductor substrate 1, mainly made of indium phosphide and a lower clad layer 3, a core 4 and an upper clad layer 5 (omitted in FIG. 17) are formed one atop another on the groove 2.

On the semiconductor substrate 1, the groove 2 is rectilinearly formed with the A-A′ section as the starting point, but the groove 2 starts to curve at some midpoint while keeping the width constant.

When the groove 2 is formed on the semiconductor substrate 1 made of indium phosphide, if an etching solution based on hydrochloric acid and the resist 6 explained in (Embodiment 2) are used, in the linear part of the opening of the resist 6 formed in a forward mesa direction, the (111) plane is exposed on the groove 2, but as the groove 2 curves and deviates from the forward mesa direction, the orientation of the exposed plane of the groove 2 changes and as a result, the groove 2 becomes shallower. Here, the forward mesa direction is the <11\overline{}> direction on the (001) plane of the substrate. Using this method, it is possible to reduce the cross section of the core 4 while curving the core 4 and convert the spot size.

This (Embodiment 3) controls the depth of the groove 2 by curving the groove 2 while keeping the width of the groove 2 constant, but it is also possible to more accurately control the depth of the groove 2 by changing the width of the groove 2 and at the same time curving the groove.

In the above embodiments, the distance between the bottom section of the groove 2 and the core 4 on the B-B′ section becomes smaller. This is no problem when the material of the semiconductor substrate 1 is transparent, but when the material of the semiconductor substrate 1 absorbs light, the light that seeps out to the bottom of the groove 2 is absorbed by the semiconductor substrate 1.

Therefore, as shown in FIG. 20, if a highly reflective film 7 is formed on the groove 2, the light is reflected by the highly reflective film 7 even if the distance between the core 4 and groove 2 is smaller than the seep-out distance of the guided light, preventing the light from being absorbed by the semiconductor substrate 1. This further increases the degree of freedom in the design of the groove 2.

Since the intensity distribution of the guided light becomes asymmetric by the highly reflective film 7 at the bottom of the groove 2, the reflected light from the core 4 becomes slightly wider or asymmetric, but most of the light is emitted at a narrow radiation angle, thus preventing the advantage in coupling with optical active elements or optical fibers from being lost.

As the materials for the core layer and clad layer in the embodiments above, high polymer materials such as <1> vinyl-based organic molecules, <2> siloxane-skeleton polymer and <3> condensation-polymerization-based organic molecules can be used. However, the refractive index of the core layer is greater than that of the clad layer.

<1> As vinyl-based organic molecules, poly methyl methacrylate (PMMA), PMMA fluorinated, PMMA deuteride, cross-linked PMMA, alicyclic group introducing denatured PMMA, poly ethyl methacrylate and copolymer with other vinyl compounds can be enumerated as examples.

<2> As siloxane-skeleton polymer, many kinds of denatured poly siloxane are available and photo-sensitive poly siloxane derivative, denatured poly siloxane fluorinated can be enumerated as examples.

<3> As condensation-polymerization-based organic molecules, various polymers denatured using condensation high polymers such as polyimide fluorinated, thermosetting polyester, polycarbonate as the skeleton are available and many copolymers and derivatives in addition to photosensitive polyimide fluorinated, epoxy denatured polyester resin, acryl denatured polycarbonate, etc. are available. Polyimide fluorinated, poly methacrylate fluorinated or poly siloxane fluorinated, etc. can be enumerated as examples.

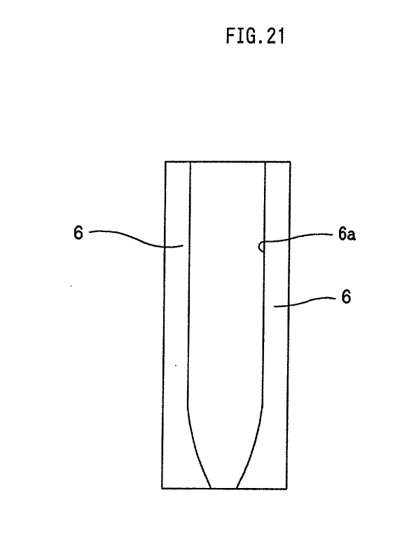

In (Embodiment 2) above, the belt-figured opening 6a of the resist 6 becomes rectilinearly narrower from the incoming end to the outgoing end. However, it is also possible to form the section from the incoming end to the position just before the outgoing end with a constant width as shown in FIG. 21 and gradually narrow the width from the position just before the outgoing end to the outgoing end, thereby controlling the shape of depth from the incoming end to the outgoing end of the groove 2.

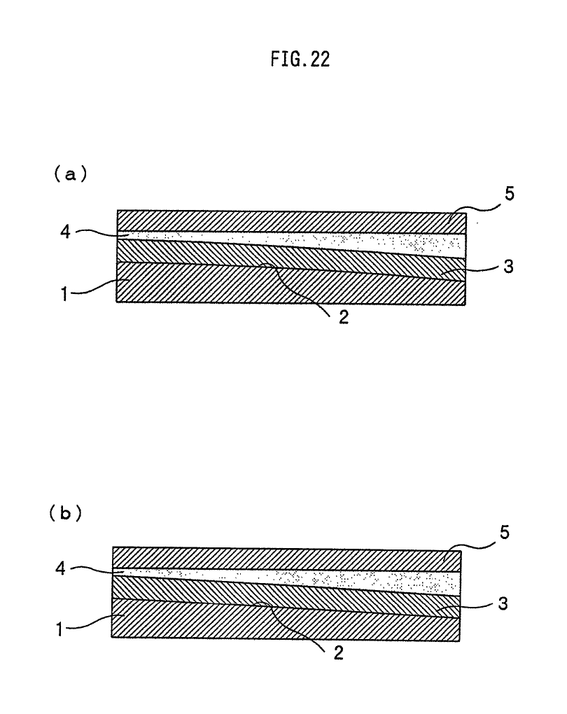

In the above embodiment, the shape of depth from the incoming end to the outgoing end of the groove 2 is composed of a gentle downward curve, which is deepest at the incoming end, becomes gradually shallower toward the outgoing end. However, as shown in FIG. 22A, the shape of depth from the incoming end to the outgoing end of the groove 2 can also be composed of a gentle upward curve, which is deepest at the incoming end, becomes gradually shallower toward the outgoing end or composed of a straight line as shown in FIG. 22B.

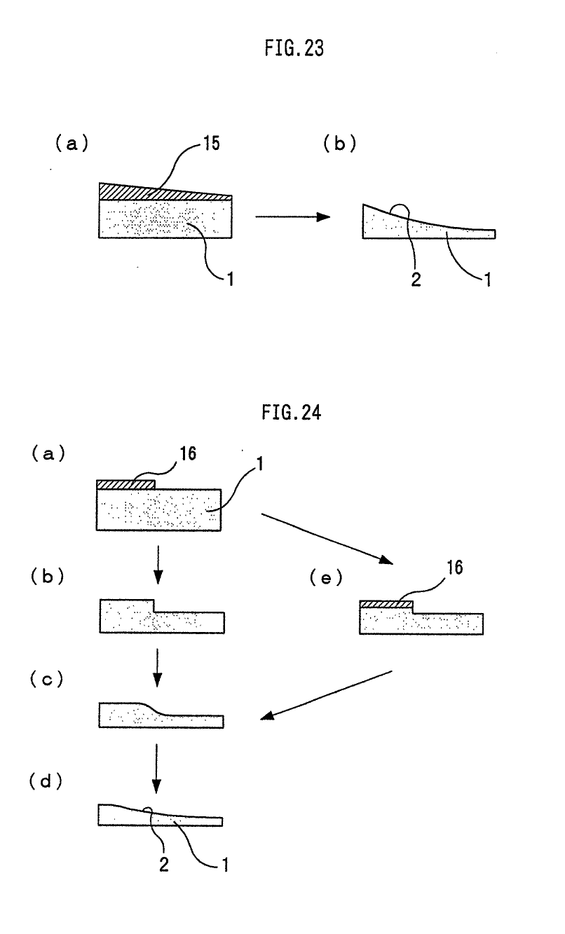

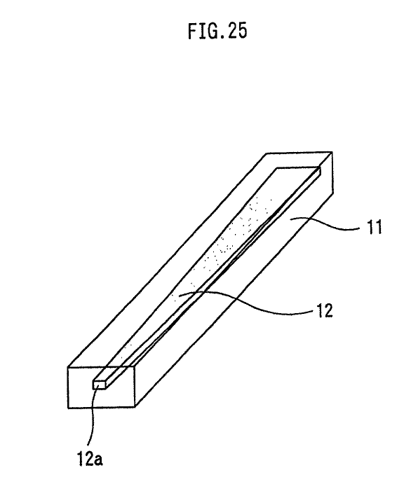

The groove 2 in the above embodiments is formed by etching the semiconductor substrate 1 exposed to the opening 6a whose surface is not covered with the resist 6 by leaving resist 6 as the mask. However, as shown in FIG. 23A, it is also possible to form a resist 15 whose outgoing end side is thicker than the incoming end side on the semiconductor substrate 1 and then remove the entire resist 15 by etching to form the groove 2 whose depth is controlled.

Furthermore, as shown in FIG. 24A, it is possible to form a resist 16 only on the part near the outgoing end where the depth of the groove 2 of the semiconductor substrate 1 is to be reduced and start etching, then remove the resist 16 at some midpoint of etching as shown in FIG. 24B and perform etching as shown in FIG. 24C and 24D to form the groove 2 whose depth is controlled or it is also possible to perform etching on the entire resist 16 without removing the resist 16 at some midpoint of etching to form the groove 2 whose depth is controlled.

As shown above, the optical waveguide of the present invention includes a core for the optical waveguide enclosed with a clad, whose cross section in the direction crossing the light traveling direction changes, and therefore can attain a satisfactory transmission characteristic independent of the polarization direction.

Furthermore, the method for making an optical waveguide according to the present invention for making an optical waveguide having an optical waveguide core formed on a substrate is characterized by forming a mask with a band-shaped opening formed in the setting direction of the optical waveguide core on the substrate, changing the width of the opening in the setting direction, etching the surface of the substrate exposed to the opening using the mask to form a groove whose depth varies in the setting direction, forming a clad material in the groove, stacking a core material made of light-propagable material from one end to the other end of the groove on the clad material, and etching the core material to form the core whose section has a quasi-square shape and whose cross section decreases from one end to the other end of the groove in the light traveling direction, and therefore the present invention can form the core symmetric with respect to the vertical and horizontal directions without requiring a complicated three-dimensional processing technology. Furthermore, using anisotropic etching makes it possible to accurately form grooves on the substrate. Moreover, by forming a highly reflective film at the bottom of the groove, the present invention can change the spot size without increasing any propagation loss.

What is claimed is:

1. An optical waveguide having an optical waveguide core enclosed with clads,
wherein a cross section of said core in a direction crossing a light traveling direction changes.

2. An optical waveguide having an optical waveguide core enclosed with clads,
said optical waveguide comprising:
a groove formed on a surface of a substrate so that a cross section of said core in a light traveling direction changes; and
the core formed on said groove via the clad, whose cross section changes in the light traveling direction.

3. The optical waveguide according to claim 1 or claim 2, wherein the cross section of said core decreases from a light incoming end to an outgoing end in the light traveling direction.

4. The optical waveguide according to any one of claims 1 to 3, wherein said core has a quasi-square sectional shape.

5. The optical waveguide according to any one of claims 1 to 3, wherein a reflective film is formed on a bottom face or inner surface of said groove.

6. A method for making an optical waveguide having an optical waveguide core formed on a substrate, comprising the steps of:
forming a mask with a band-shaped opening formed in a setting direction of the optical waveguide core on the substrate and changing the width of said opening in said setting direction;
etching a surface of said substrate exposed to said opening by using said mask to form a groove whose depth varies in said setting direction;
forming a clad material in said groove;
stacking a core material made of light-propagable material from one end to the other end of said groove on said clad material; and
etching said core material to form said core whose cross section decreases from one end to the other end of said groove in a light traveling direction.

7. A method for making an optical waveguide having an optical waveguide core formed on a substrate, comprising the steps of:
forming a mask with a band-shaped opening formed in a setting direction of the optical waveguide core on the substrate and curving the shape of said opening from one end to the other end of said groove;
etching a surface of said substrate exposed to said opening by using said mask to form a groove whose depth varies in said setting direction;
forming a clad material in said groove;
stacking a core material made of light-propagable material from one end to the other end of said groove on said clad material; and
etching said core material to form said core whose cross section decreases from one end to the other end of said groove in a light traveling direction.

8. The method for making an optical waveguide according to claim 6 or claim 7, wherein said core material is etched and said core is formed into a quasi-square shape.

9. The method for making an optical waveguide according to claim 6 or claim 7, wherein said semiconductor substrate is made of silicon and a main plane of said semiconductor substrate is a plane and said groove is parallel to a <11\overline{}0> direction of said semiconductor substrate.

10. The method for making an optical waveguide according to claim 6, wherein a resist of varying thickness is formed on the semiconductor substrate and a groove is formed by etching the semiconductor substrate together with the resist.

11. The method for making an optical waveguide according to claim 6, further comprising the steps of partially forming a resist on the semiconductor substrate, and removing said resist at some midpoint of etching and continuing etching or etching the semiconductor substrate together with said resist without removing said resist at some midpoint of etching to form a groove of varying depth.
